(19) United States
(12) Patent Application Publication
(10) Pub. No.: US 2026/0002393 A1
(43) Pub. Date: Jan. 1, 2026

(54) OPENING AND CLOSING SECURITY MECHANISM

(71) Applicant: BBG, S.A., Esposende (PT)

(72) Inventor: Bruno Daniel OLIVEIRA BRAS, Vila do Conde (PT)

(21) Appl. No.: 18/881,289

(22) PCT Filed: Jun. 15, 2023
(86) PCT No.: PCT/IB2023/056224

§ 371 Date: Jan. 5, 2025

(30) Foreign Application Priority Data
Jul. 8, 2022 (PT) 118096

(51) Int. Cl. E05C 1/04

(52) U.S. Cl. CPC E05C 1/04

(57) ABSTRACT

The present invention concerns an opening and closing security mechanism that promotes the disruption of the concept of the opening and closing security mechanism being located in the movable panel (1), hence it deletes the same from this feature and places it in the frame (3), this frame (3) being comprise of the fixed frame (4), together with a locking box (5) embedded in the wall of the building (10). This change in the location of the opening and closing security mechanism, as well as the locking/unlocking mechanism, from the movable panel (1) to the frame (3) and consequently to the fixed frame (4) allows the movable frame (2) to have very reduced dimensions compared to the state of the art. Additionally, the present invention presents a box (5) embedded inside the wall of the building (10) that will receive this fixed frame (4), allowing the same reading throughout its perimeter, not taking up space in the mobile part—movable panel (1).

### FIELD OF THE INVENTION

This invention relates to an opening and closing security mechanism, in particular multipoint security locks, in particular multipoint locking systems embedded or concealed by the interior and exterior covering of the constructive envelope/surroundings of the framework, in this case, doors, windows whether opening by horizontal or vertical displacement or by rotation on an axis or rotation accessory placed on the fixed frame, in particular in large spans. More specifically, these opening and closing security mechanisms can comprise a lock with an external or internal barrel and also a handle or a mechanical actuator for moving the lock placed at the profile of the fixed frame.

### BACKGROUND OF THE INVENTION

The present invention relates to a security mechanism for opening and closing windows, doors and balconies, opening to the outside “English Opening” or to the inside “French Opening”, pivoting with a vertical or horizontal axis, multi-panel guillotines including movable panels models, hidden or integrated in a pocket or in a box or spare pocket installed in the building.

Balconies are understood to be openings in buildings that are not intensively used doors and have a configuration similar to a window with a fixed perimeter frame or with a low threshold (up to a maximum of 20 mm), however they can extend in height from the ground (threshold) up to the height of the ceiling, occupying a height corresponding to at least 1 double height, considering the height of the ceiling fixed in the European regulation, the highest, applicable to the construction, thus allowing a user to enter and leave the building through them, the typical verandas, porches, decks.

For a better understanding of this type of objects, it is important to approach to the definitions known by experts, whereby it is defined that these objects, windows or balconies, have at least one movable panel (1), which has a movable frame (2) around its entire perimeter, this movable panel (1) is typically made of glass, which can be single, double, triple, etc. In addition to this movable panel (1), and it should be understood that when we refer to the movable panel (1) we are considering the movable frame (2) and glass(s) set, we also have the frame (3), which is the fixed frame (4) to the opening of the building where at least one movable panel (1) is installed. It should be added that the plate test or strike plates, in the context of this application, concerns the technical element of French translation “gache”, which is nothing more than the plate that is fixed to a frame to receive in its at least one hole, the at least one-point closing. The type of object we are referring to is thus defined.

Windows or balconies have, for the safety of their users and for the protection of the interior of buildings, opening and closing mechanisms, with one point or multiple points of closure (multipoint), and this has the function of blocking the movable panel in the position closed. In turn, the particularities of this blocking mark the resistance to intrusion from the outside, making it difficult for people to enter the building through the frame. These opening and closing mechanisms have different configurations and have evolved over time. These mechanisms are also subject to a wide range of tests, not only for functional cycles but also for anti-intrusion resistance through tests defined in a European Standard whose purpose is to characterize the anti-intrusion performance of the frame on a well-defined scale, which are then classified according to references to the tools, manual or electric, used to dismantle it and the time taken to open it. The objective is to define, through a test, how long it would take a thief to enter through a window or balcony/door that uses certain tools, and that the window or balcony/door has certain opening and closing security mechanisms.

In the 1970s, most closing mechanisms were applied to the central or lateral uprights of the movable panels (1) (typically at this time there were only two movable sliding panels, single glass), they generally had a handle also located on the central plumb for the user to move the panels, and many of these handles also had a button on the front (that is, facing the interior of the building) that, through its own means, skewed the movable panels or unlocked them. This characteristic of the product has marked the entire industry until today, that is, all existing solutions use the mechanism for transmitting the closing movement on the moving panel, integrating the movement handle in that location, whether this transmission is performed by rotation or by translation, in short, the opening and closing security mechanism was located in the movable panel.

However, there is an evolution in this technology, since these mechanisms over time made it difficult for the panel to run, facilitating the appearance of gaps and often letting moisture pass through and above all not promoting optimal closing, as the user did not have how to ensure that the window or balcony/door closed and blocked, as what was blocking was one panel with the other, but not with the frame fixed around it, allowing the entry of wind, humidity and noise. It was when the opening and closing systems also appeared located on the movable frame, but instead of being on the central plumb, it was and still is mostly on the sides, this mechanism has the advantage that the panels are fixed to the frame (frame fixed to the building, e.g., to the wall) and not to each other, as in the previous system.

This system has the advantage of greater isolation from sound, humidity and cold, many of these systems also have a locking mechanism, which has different configurations, in most cases making a movement with the handle, which in most situations is a recess that allows the user to move the panels. However, it is still an opening and closing security mechanism located on the movable panel, which implies that the movable frame has a sufficient dimension to house and incorporate all the material and parts that constitute it, increasing its dimension, making its replacement difficult and maintenance. It also implies that its tuning and adjustments, necessary over time, are time-consuming and often imply the complete replacement of the movable panel.

### SUMMARY OF THE INVENTION

The present invention solves the aforementioned problems and optimizes them and others, promoting a disruption of this concept of the opening and closing security mechanism being located on the movable panel (1), once it removes it from this component—the movable panel (1)—and places it in the frame (3), consisting of the fixed frame (4), together with a locking box (5) embedded in the wall of the building (10).

This change in the location of the opening and closing security mechanism, as well as the locking/unlocking mechanism, from the movable panel (1) to the frame (3) and consequently to the fixed frame (4) allows the movable frame (2) to have very reduced dimensions compared to the state of the art, it achieves, particularly and if desired, that the movable frame (2) has a view around its entire perimeter, in particular of 18 mm (see FIG. 1). This configuration, in addition to reducing the structure on the movable panel (1) to a minimum view, facilitates its assembly and disassembly, brings greater luminosity inside the buildings, allows the calibration of the components on the frame (3)—there is no need for dismantling the movable panels (2)—simultaneously ensures control of glass deformation, since the amount of the movable panel (2) has a built-in support along the entire length of the jamb.

Thus, the present solution has the advantage of allowing to reach a perimeter view of the movable frame (2), that is, it allows the visible measure of the profile to be the same in all its extension, for example in a window that the frame (3) that supports the glass (11), or glass (11), is the minimum possible and with exactly the same visible measure around its entire perimeter if so desired, which is an innovative way of presenting windows/balconies, which in general present higher measurements on the profiles that house the closing and opening mechanisms compared to those that do not.

Additionally, the fact that the present invention is located, on the one hand, integrated inside the fixed frame (4), on the other hand, having the mechanism that activates it integrated in a box (5) embedded inside the wall of the building (10) that will receive this fixed frame (4), allowing you to have the same reading throughout its perimeter, not taking up space in the movable part-movable panel (1)—thus being able to reach a view of only 18 mm of aluminum.

It should also be mention that the box (5) is closed, that is, it is tight to the entry and exit of air-airtight, which improves the permeability of this factor, avoiding the so-called parasitic air entries in the area that reduce the energy efficiency of buildings, the present invention with this airtight box increases the energy efficiency of the frame and as such of the building.

The strike plates (6) or “gaches” (French term) FIG. 2—are then located on the movable panel (1), specifically on the mobile frame (2) and not on the frame (3), specifically on the frame fixed (4), like the others in the state of the art, however this component is much smaller in terms of dimensions than a closing system, and therefore 18 mm is the minimum achievable. These strike plates (6) have holes that receive the locking points (8) for locking/unlocking them.

We can list several advantages, which will be technically explained in the detailed description of the invention:
a) High protection against aggressive external environmental elements, mainly saline and acid environments. Therefore, higher component corrosion protection;
b) Simplified maintenance by integrating low-friction components and sliders and compatibility with the application of high-security cylinders, allowing the fixed frame (4) to be integrated into key display schemes;
c) Movement transmission rods protected by an anti-intrusion bridge, since, as will be detailed later, the present invention presents an anti-false maneuver mechanism, located in the fixed frame (4), another innovation of the present invention. In the state of the art these mechanisms are found in the movable panel (1) and the intrusion by a thief is facilitated, in the present invention and according to the FC3 tests carried out, it takes more time and more complex tools to penetrate this mechanism, this too, and it is easy to understand, as most of it is built into the wall in a waterproof box;
d) High watertightness and reduced passage of air by simplifying the machining operations of both the movable panel (1) and the frame (3), these components are more adjusted than those existing in the state of the art;
e) Optimization of the energy performance of the frame by optimizing the surface exposed to solar radiation (greater) and the ambient temperature, since the entry and exit of air, noise and water is reduced;
f) area of thermal transmission in the movable panel (1) with reduced exposure, therefore the impact on the reduction of the linear thermal transmission Uf coefficient of the lateral upright node;
g) greater entry of natural light by reducing the areas exposed on the side pillar (optimization of the Tlw indicator), since the perimeter of the movable frame (4) is very small;
h) Reduction of the level of secondary thermal absorption by reducing the exposed area of the profile (optimization of the Sw indications);
i) Possibility of integrating systems with high anti-intrusion resistance, as both the locking box (5) and the rods (12) and strike plates (6) for retaining the movable panel (1) are protected by the materials used in the construction a since they are integrated into them;
j) Aesthetic advantages since it is possible to completely hide all the structural components of the fixed frame;
k) The solution by expanding the glass area (11) in the total area of the span presents a high potential to guarantee remarkable results both in terms of ballistic protection and in terms of anti-explosion protection for the occupants of the building.

### DESCRIPTION OF THE FIGURES

FIG. 1-representation of an embodiment of a horizontal section, where the 18 mm dimension can be seen, both for the movable frame (2) and the central plumb, that is, around the entire perimeter of the movable panel (1), a since it is in the frame (3), constituted by the fixed frame (4) and the closing mechanism is located, together with a locking box (5) embedded in the wall of the building (10).

FIG. 2-representation of the strike plate (6), where at least one hole is represented that will receive at least one closing point.

FIG. 3-Cut representation of the frame (3) and the movable panel (1) mounted on the building (10), and where the top of the locking box (5) embedded in the wall can be seen, observing the handle (7), handle (9), rod (12) and tongue (13), in this configuration the movable panel (1) consists of double glass (11).

FIG. 4-Representation of the locking box (5), in perspective (view A), front (view B), side view of the inside part of the building (view C), side view of the outside part of the building (view D), top view (E) and base view (F).

FIG. 5-Representation of the preferred embodiment of the invention when it can have two handles for two different closing systems, the perspective view A, the side view B and the front view C.

FIG. 6-Representation of the inside of the box (5) where the profiles (15) are visible, for fitting the components inside.

FIG. 7-Representation of the locking box (16), observing the barrel (14).

FIG. 8—cut representation of the frame (3) and the movable panel (1) mounted on the building (10), observing the handle (7), handle (9), rod (12) and tongue (13) (17), locking point (8), strike plate (6), in this configuration the movable panel (1) consists of double glass (11) and has a barrel (14) on the outside, the locking box (5) and the box that houses the barrel are seen from the top.

FIGS. 9 and 10-representation of the handle (7) in various views, observing the locking points (8) and in FIG. 10 in greater detail.

FIG. 11-Representation of the strike plate in perspective (view B), front (view C), side (view A), where the anti-false maneuver mechanism and the corresponding anti-false maneuver counter (18) and the closing points are represented (8) mushroom type that block the rod.

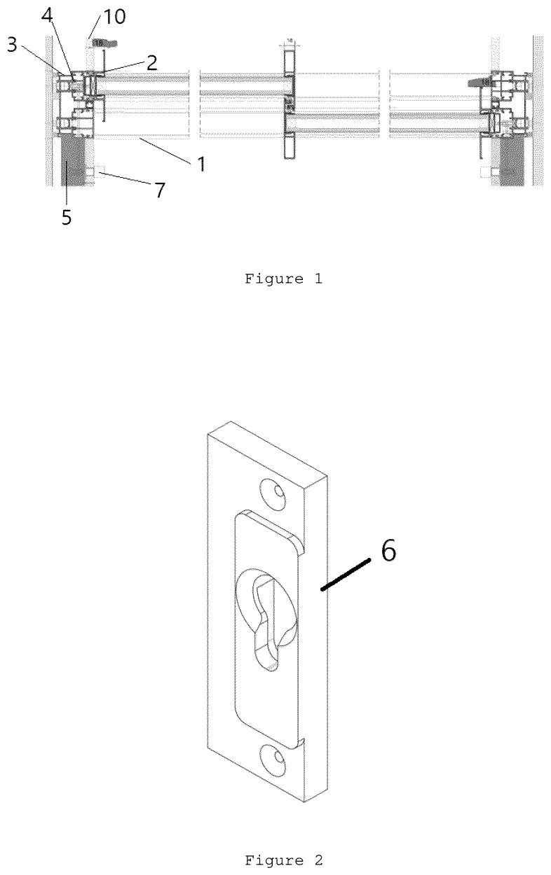

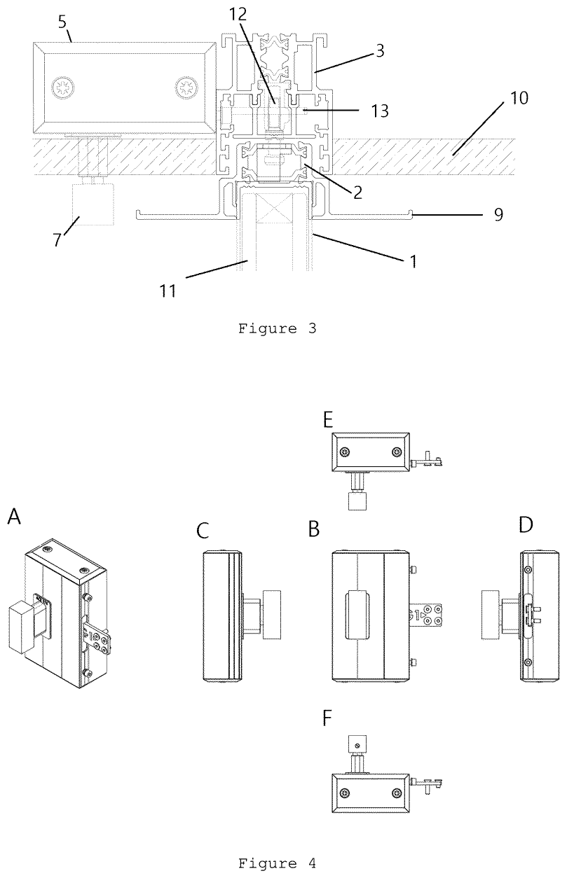

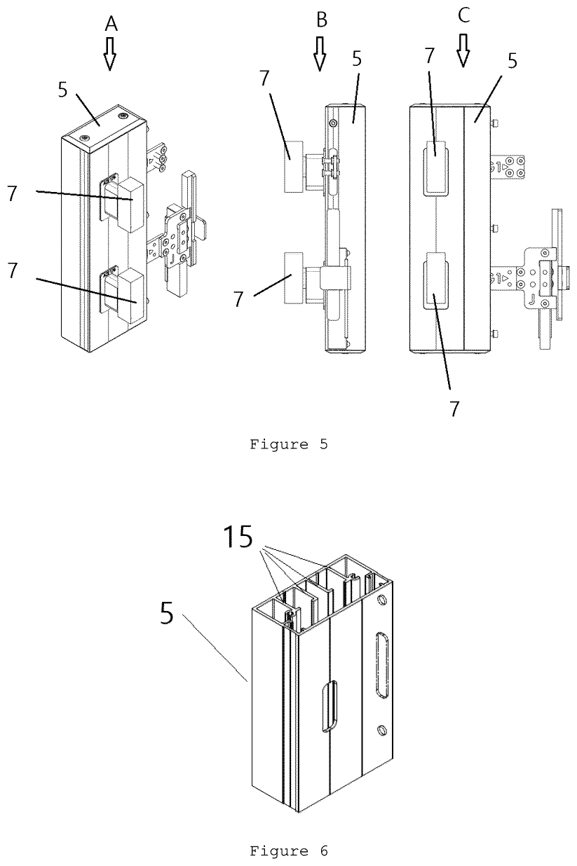

### DETAILED DESCRIPTION OF THE INVENTION

The present invention concerns an opening and closing security mechanism, hereinafter referred to as a closing mechanism only for the sake of simplicity of the present text, comprising part of its components located on the frame (3), constituted by the fixed frame (4), together with a locking box (5) embedded in the wall of the building (10) where the frame (3) is fixed. In this way, the strike plates (6) are located on the movable panel (1), specifically on the movable frame (2). The locking box (5) will be embedded in said wall, being completely invisible to the user, however, it has at least one handle (7), which together with at least one rod (12), which has locking points (8), and which, together with a tongue (13) that is fixed to the handle (7) and has a joint/solidarity movement with it, but extends to the outside of the locking box (5) in order to fix itself on the rod (12) by fitting in the locking points (8), allows the opening or closing of the movable panel (1) in relation to the frame (3). This configuration of the locking points (8) being on the rod (12) and not on the fixed frame (4), is an added value and an improvement, as it allows for a hidden closing, the possibility of adjustments and adjustments that are necessary to the over time, as these materials spontaneously gain clearance.

The handle (7) when moved vertically and upwards, jointly moves the tongue (13) also vertically, unblocking it from the locking points (8) constituting the rod (12) which is fixed to the movable frame (2), being able to in this way the movable panel (1) will be opened. The downward vertical movement closes and blocks its opening, exactly the same principle, but in the opposite direction of movement, allowing the closing of the movable panel (1).

This locking box (5) is a piece with profiles (15) for fitting the handle (7) incorporated, this innovation reduces the appearance of gaps between these components (profiles, box, handle), reduces the necessary material such as screws for Placing the profiles inside the locking box (5) reduces assembly time and increases the durability of the closing system.

In a preferred configuration of the present invention, the locking box (5) has two handles (7), one of which has its so-called normal use, that is, to allow closing and opening of the movable panel (1), and the second can having another integrated system-FIG. 5, such as a mosquito net, as preferably described in patent document EP3805515.

In a preferred configuration of the present invention, the movable frame (2) and/or the fixed frame (4) are made of aluminum.

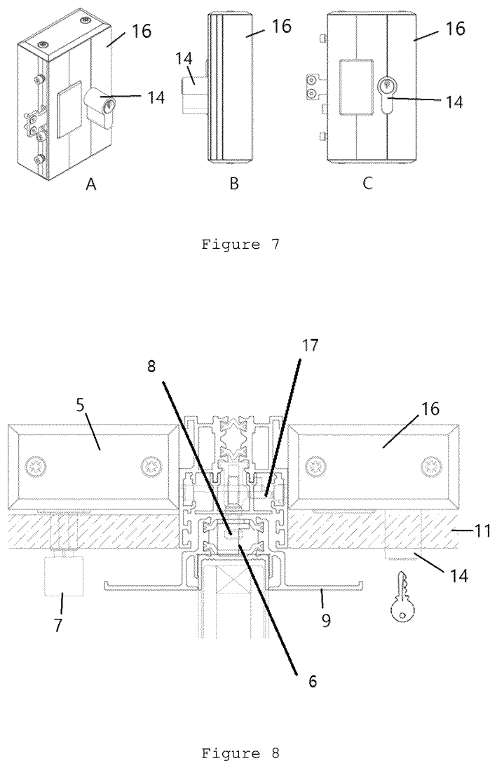

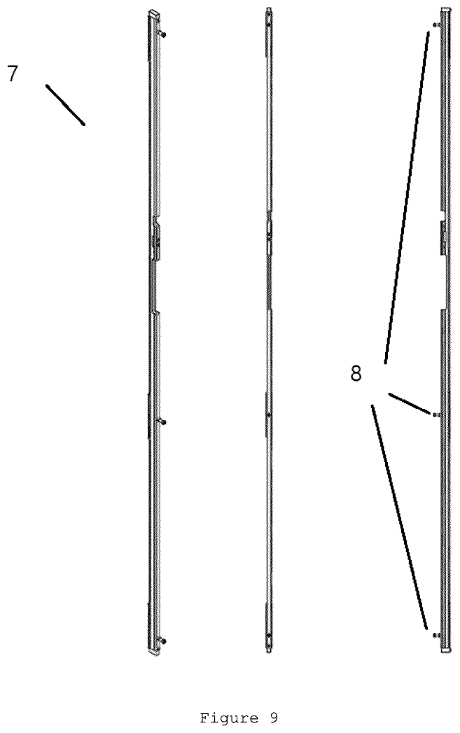

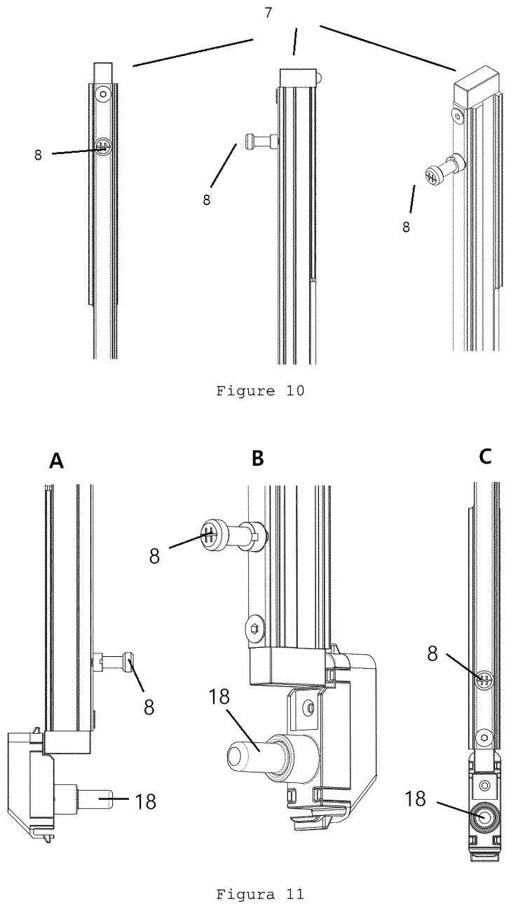

In an alternative the present invention, it presents an exterior barrel (14), FIGS. 7 and 8, thus allowing the closure from the outside of the building (10) of the balcony or window with a key. This configuration requires that there is a locking box (16), on the opposite side of the locking box (5) in relation to the frame (3), which also has a tongue (17), which, when activated, fits into the locking points (8). In this case, the rotation movement of the key in the barrel, transmits movement to the tongue (17) blocking the locking points (8) constituting the rod (12) which is fixed to the movable frame (2), thus closing the movable panel (1). The opposite rotation movement unlocks its opening, exactly the same principle, but in the opposite direction of movement, allowing the opening of the movable panel (1).

It is also necessary to mention that the present invention incorporates an anti-false maneuver mechanism, the objective of which is to ensure that when the locking points (8) engage the handle (7), the position of the locking points (8) prevents hit directly outside the slot of entry and centre of the locking point (8) allowing, then, by pressing the anti-false maneuver counter (18) to unlock the vertical movement of the rod (12) and consequently move the locking points (8) into the movable panel (1) retaining groove. The anti-false maneuver mechanism also prevents the rod (12) from having any vertical movement if the movable panel (1) is not positioned against the fixed frame (3). Thus, it is guaranteed that even inadvertently the user is closed on the balcony or outside the house, which happens regularly with conventional locks with a return spring, he can open the movable panel (1).

It should be noted that preferably the locking points (8) are of the mushroom type, so that they engage in the holes in the strike plate, and with the downward movement of the tongues (13) (17) they are blocked and not just engaged.

In an alternative the present invention, the movable panel (1) comprises a movable frame (2) with an integrated handle (9), FIG. 5, however this handle (9) can be another configuration as long as it performs its well-known function to help the user slide the window, as well as it may not have a handle if it is a motorized window, that is, its opening is carried out with the aid of strategically placed motors, as well as all the necessary logistics.

As will be clear to one skilled in the art, the present invention should not be limited to the embodiments described herein, and a number of changes are possible which remain within the scope of the present invention. Of course, the preferred embodiments shown above are combinable, in the different possible forms, being herein avoided the repetition all such combinations.

1. Opening and closing security mechanism comprising
at least one frame (3) comprising a fixed frame (4), at least one movable panel (1) with a movable frame (2), wherein it comprises:
a) at least one locking box (5) embedded at a wall of a building (10) where the frame (3) is fixed, the locking box (5) comprising at least one handle (7);
b) strike plates (6) located on the movable frame (2) of the movable panel (1);
c) at least one rod (12) comprising has at least one locking point (8);
d) at least one tongue (13) fixed to at least the one handle (7), said tongue (13) moving together with the handle (7) and extending to the outside of the locking box (5) fixing to the rod (12) through the fitting in the locking points (8);
where the at least one handle (7):
when moved vertically and upwards, jointly moves the tongue (13) also vertically, unblocking it from the locking points (8) of the rod (12), said rod (12) being fixed to the movable frame (2) allowing the movable panel (1) to be opened; and
when moved vertically and downwards, jointly moves the tongue (13) also vertically, blocking the locking points (8) of the rod (12), said rod (12) being fixed to the movable frame (2) allowing the movable panel (1) to be closed.

2. Mechanism according to claim 1 wherein the locking box (5) comprises profiles (15) for fitting the handle (7) incorporated.

3. Mechanism according to claim 1 wherein the locking box (5) comprises two handles (7), one handle allowing the closing and opening of the movable panel (1), and the second handle comprising a second integrated system.

4. Mechanism according to claim 2 wherein the second integrated system of the second handle is a mosquito net.

5. Mechanism according to claim 1 wherein the movable frame (2) and/or the fixed frame (4) are made of aluminium.

6. Mechanism according to claim 1 wherein further comprises:
a) at least one outer barrel (14);
b) a locking box (16), located inside the building (10), on the opposite side to the locking box (5) with respect to the frame (3), said locking box (16) comprising a tongue (17), which when activated, fits into the locking points (8); and
the rotation movement of a key in the barrel (14), transmits movement to the tongue (17) blocking it in the locking points (8) of the rod (12), said rod (12) being fixed to the movable frame (2), the movable panel (1) thus being closed and the opposite rotation movement unlocks its opening, allowing the opening of the movable panel (1).

7. Mechanism according to claim 1 wherein further comprises an anti-false maneuver mechanism located on the movable frame (2) and comprising a counter (18), said counter when pressed, unlocks the vertical movement of the rod (12) by moving the locking points (8) to a retaining groove of the movable panel (1).

8. Mechanism according to claim 6 wherein the locking points (8) are of mushroom type.

9. Mechanism according to claim 1 wherein the movable panel (1) comprises a movable frame (2) with a handle (9).

10. Mechanism according to claim 1 wherein the handle (9) is integrated in the movable panel (1).

11. Mechanism according to claim 1 wherein further comprises at least one motor for opening and closing the at least one movable panel (1).

12. The mechanism according claim 6 wherein further comprises an anti-false maneuver mechanism located on the movable frame (2) and comprising a counter (18), said counter when pressed, unlocks the vertical movement of the rod (12) by moving the locking points (8) to a retaining groove of the movable panel (1).
